(19) United States
(12) Patent Application Publication
(10) Pub. No.: US 2020/0054045 A1
(43) Pub. Date: Feb. 20, 2020

(54) All-Natural Drink Composition for Synthesizing and Regenerating Adenosine Triphosphate (ATP) in Muscle Cells and Neurons, Repairing Exercise-Induced Muscle Fiber Damage, Repletion of Glycogen Stores in the Muscle and Liver, Enhancing Blood Flow to Tissue during Intense Exercise, and Preventing and Reducing Oxidative Damage to Tissues during Exercise with Minimal Gastrointestinal Disturbances

(71) Applicant: Biomechanical Technologies, LLC, Norristown, PA (US)

(72) Inventors: Michael James Schmidt, Norristown, PA (US); David Avarbock, Lansdale, PA (US)

(21) Appl. No.: 16/665,954

(22) Filed: Oct. 28, 2019

Related U.S. Application Data
(63) Continuation of application No. 12/584,367, filed on Sep. 3, 2009, now abandoned.
(60) Provisional application No. 61/093,771, filed on Sep. 3, 2008.

(51) Int. Cl. A23L 2/395; A23L 2/66; A23L 33/155; A23L 33/195; A23L 33/19; A23L 33/185; A23L 33/26; A23L 33/00; A23L 33/125

(52) U.S. Cl. CPC A23L 2/395; A23L 2/66; A23L 33/155; A23L 33/195; A23L 33/125; A23L 33/185; A23L 33/26; A23L 33/30; A23L 33/19

(57) ABSTRACT

The present invention provides for a nutritional composition in a liquid drink form, dry powder form, gel form, or carrier form intended to optimize human physiological performance during intense exercise and subsequently return the body to its healthy, pre-exercise state. The composition comprises a carbohydrate and a protein, and preferably a ratio of the carbohydrate to the protein is greater than about 4.3 parts by weight carbohydrate to 1 part by weight protein. Preferably, the liquid nutritional composition is comprised of: (1) carbohydrate in the range of 3.45-10% by weight of the liquid nutritional composition to allow immediate and long-term energy production by muscle cells and neurons, insulin modulation, and muscle glycogen sparing, the carbohydrate being in the form of monosaccharides or polysaccharides or a combination thereof, and the saccharides preferably comprising 40-95% dextrose by weight of the final volume of saccharides, 5-45% fructose by weight of the final volume of saccharides, and 1-25% glucose polymer by weight of the final volume of saccharides; (2) a protein source that contains all 20 “standard” amino acids, in the range of 0.1-0.8% by weight of the liquid nutritional composition, whose inherent structure plus further chemical modification results in amino acid absorption into the bloodstream rapid enough for initiating and enhancing protein synthesis and subsequent muscle cell repair during the exercise and post-exercise periods; (3) Branched-Chain Amino Acids (BCAA), leucine, isoleucine, valine, for use by muscle cells for energy thus sparing glycogen stores, for increasing protein synthesis by stimulating insulin and growth hormone release, and for reducing protein degradation; (4) precursors of the signaling molecule nitric oxide, important for increasing blood flow and subsequent nutrient delivery (including those in this composition) to tissue during intense exercise; (5) precursors of creatine, a molecule important for ATP regeneration in muscle and nerve cells and for muscle cell volumizing effects; (6) a mixture of hydrophilic and hydrophobic antioxidants: retinol/Beta-carotene (Vitamin A), ascorbic acid (Vitamin C), and di-alpha-tocopheryl acetate (Vitamin E); ubiquinone (coenzyme Q₁₀ [5-100 mg/500 ml], which in addition to its antioxidant properties is also important for ATP generation and Vitamin E regeneration; a mixture of 10-100 mg epigallocatechin gallate (EGCG) and 25-150 mg polyphenols from green tea extract; 40-250 mg ellagic acid and punicalagin from pomegranate or raspberry extract, at ratios comparable to that found in the whole fruit, which have been shown to have protective effects on blood vessels as well as inhibiting stimulation of the pro-inflammatory protein interleukin-1b (IL-b) which causes degradation and damage to joints (These six antioxidants prevent and eradicate reactive oxygen species and free radicals generated during strenuous exercise, thus preserving muscle integrity.); and (7) the ions Na+, Cl−, K+, Ca+2, Mg+², and Zn+², which are important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes.

### CROSS-REFERENCE TO RELATED APPLICATIONS

This application claims priority to U.S. Provisional Application Serial Number U.S. 61/093,771, filed on Sep. 3, 2008, the complete disclosure of which is herein incorporated by reference.

### FIELD OF THE INVENTION

The present invention relates to a nutritional composition for optimizing the intensity and duration of muscle activity during exercise and sport performance, and preventing muscle damage during and after exercise while not causing gastrointestinal disturbances. More particularly, the nutritional composition in a preferred embodiment of the invention includes: dilute levels of protein along with carbohydrates to stimulate insulin release and facilitate glucose and amino acid uptake into muscle cells during exercise, and to enable immediate muscle repair to begin; leucine, isoleucine, and valine to increase protein synthesis by elevating insulin and growth hormone levels, reduce protein degradation, and to be utilized by muscle cells for energy, thus sparing glycogen; Vitamins C, E, and A, EGCG and green tea polyphenols, Coenzyme Q10, and the polyphenols, punicalagin and ellagic acid for reducing reactive oxygen species and free radical buildup; and one or more electrolytes for replenishing electrolytes lost during exercise, while not delaying gastric emptying or perturbing the gastrointestinal track.

### BACKGROUND OF THE INVENTION

Numerous research studies have been published detailing the critical role hydration and carbohydrate and electrolyte supplementation play in maintaining an athlete's optimal exercise intensity. These studies indicate that when an athlete consumes a sports drink during exercise containing carbohydrate and electrolytes, the athlete can increase his intensity and endurance to a greater extent than by consuming just water. This research initiated the commercial development of sports drinks containing carbohydrate in the range of 6-8% and electrolytes such as sodium, potassium, magnesium and chloride.

Sustaining optimal energy levels during a training session, rapid muscle recovery and return to pre-workout homeostasis between training sessions are the fundamental goals of sport nutrition, particularly in high level competition where athletes typically engage in more than one session per day. The rate at which an athlete's body absorbs nutrients is a fundamental factor in determining the efficacy of this nutrition regimen.

The sport beverage is the most common modality the athlete uses to achieve these goals. The composition of the sport beverage determines how rapidly water, ions, and macromolecules such as carbohydrates and proteins are absorbed. The concentration of carbohydrate and sodium in the sports beverage are the major determinants of the absorption rate in the small intestine. The higher the carbohydrate and sodium concentration the slower the rate of water uptake.

The sport drink must prevent dehydration, depletion of energy stores, and loss of critical ions. This is accomplished by drinking the beverage: before exercising to ensure adequate hydration and maximum concentration of glycogen in the muscle; during exercise to maintain hydration, spare glycogen stores for later stages of the workout, and maintain adequate concentrations of critical ions for the muscle contraction and relaxation cycle; and after exercise to ensure replacement of any deficit in fluid, replenish ions necessary for reestablishing fluid homeostasis and plasma osmolality and other critical biological functions, and fill glycogen stores.

When a sports drink is consumed during exercise, glucose is transported from the blood into the muscle cells where it is converted into energy. In the non-exercise state, glucose uptake is regulated by high levels of insulin, which binds to the insulin receptor on muscle cells, causing the GLUT4 receptor to be translocated to the surface where it transports glucose into the cell by passive diffusion. However, during intense exercise, insulin production decreases and glucose is transported into the muscle with the aid of non-insulin dependent glucose transporters as well as contraction of the muscle cells, which can translocate GLUT4 receptors to the cell surface. The transport of glucose into muscle cells is critical to maintain muscle glycogen stores and extend an athlete's optimal level of performance.

Research studies have demonstrated that insulin levels can be increased with an appropriately designed sport drink, resulting in an increase in glucose uptake. However, there is a limit to how much insulin will be released: if the concentration of carbohydrate is too high in the drink it results in delayed gastric emptying, and the carbohydrate intake becomes rate limiting in its ability to stimulate insulin.

Typically the monosaccharide fructose constitutes 50% or greater of the carbohydrates in most sport drinks. Fructose must be converted to glucose in the liver before it can be utilized by the muscle cell; this process takes time as well as energy, neither of which the exercising athlete can afford to lose. In addition, much of the fructose that is consumed by the exercising athlete will not be absorbed into the muscle cells, but will be transported to the lower intestine, where it is digested by gut flora and gas is produced. This excess fructose also causes water retention in the intestine, leading to bloating and diarrhea. In the case of the synthetic high fructose corn syrup (55% fructose), there is increasing awareness about the dangers of carbonyls, which research has demonstrated cause cell and tissue damage, leading to diabetes.

It has been previously demonstrated that when protein is added to a carbohydrate in the drink, it can enhance the stimulation of insulin over carbohydrate alone. The concentration of protein is critical since protein has been shown to slow gastric emptying. U.S. Pat. No. 6,051,236 showed that when carbohydrate and protein are in a 4:1 ratio, it provides increased insulin stimulation and enhances the synthesis of muscle glycogen with no negative impact on rehydration following exercise.

Previously, U.S. Pat. No. 6,989,171 showed that when a carbohydrate to protein ratio of less than 2.8 is used, the protein has an adverse effect on gastric emptying which would slow rehydration and glucose absorption during exercise.

Previously, U.S. Pat. Application No. 20020197352 shows that when a carbohydrate to protein ratio of greater than 4.2 is used, the protein has an adverse effect on gastric emptying which would slow rehydration and glucose absorption during exercise.

A nutritional composition, marketed under the trademark “PureSport” by Human Performance Labs, LLC, is marketed as increasing stamina and quicker muscle recovery. Human Performance Labs, LLC includes a “Patent Pending” notice for its formula having a 2.67 to 1 carbohydrate to protein ratio.

There is a definite need in the art for sports drinks that accelerate the uptake of glucose by muscle cells during exercise and provide an immediate source of energy, improve endurance by sparing muscle glycogen stores, and allow for the immediate start of muscle repair, while not causing adverse side effects on the gastrointestinal track. It is an object of this invention to provide a sports drink that improves exercise and sport performance and reduces muscle and joint damage.

### DESCRIPTION OF THE PRIOR ART

Compositions for optimizing muscle performance during exercise have been disclosed in the prior art.

Portman in U.S. Pat. No. 6,051,236 discloses a nutritional composition containing carbohydrates and proteins in a ratio in the range of 2.8 to 4.2 parts carbohydrates to 1.0 part protein designed to stimulate insulin to muscle cells during exercise and for repairing muscle cells after exercise.

A nutritional composition, marketed under the trademark “PureSport” by Human Performance Labs, LLC, is marketed as increasing stamina and quicker muscle recovery. Human Performance Labs, LLC includes a “Patent Pending” notice for its formula having a 2.67 to 1 carbohydrate to protein ratio.

A sports drink to increase the uptake of glucose during exercise has been disclosed in the prior art.

Portman in U.S. Pat. No. 6,989,171 discloses a sports drink composition containing carbohydrates and proteins in a ratio in the range of 2.8 to 4.2 parts carbohydrates to 1.0 part protein designed to stimulate insulin to muscle cells during exercise and for repairing muscle cells after exercise.

Portman in U.S. Pat Application 20020197352 discloses a sports drink composition containing carbohydrates and proteins in a ratio in the range of 2.5 to 4.2 parts carbohydrates to 1.0 part protein designed to stimulate insulin to muscle cells during exercise and for repairing muscle cells after exercise.

Portman in U.S. Pat Application 20060121172 discloses a sports drink composition containing carbohydrates and proteins in a ratio in the range of 2.8 to 4.2 parts carbohydrates to 1.0 part protein designed to stimulate insulin to muscle cells during exercise and for repairing muscle cells after exercise.

Portman in U.S. Pat Application 20060193949 discloses a sports drink composition containing carbohydrates and proteins in a ratio in the range of 2.8 to 4.2 parts carbohydrates to 1.0 part protein with the carbohydrate in 3 equal parts that include glucose, fructose, and sucrose designed to stimulate insulin to muscle cells during exercise and for repairing muscle cells after exercise.

A composition for enhancing muscle recovery has been disclosed in the prior art.

Portman in U.S. Pat Application No. 20070280997 discloses a sports drink composition containing carbohydrates and proteins in a ratio in the range of 1.5 to 2 parts carbohydrates to 1.0 part protein with 2 of a group of 4 sugars and a 3:1 ratio of whey to casein protein to stimulate insulin to muscle cells and for repairing muscle cells.

Sports drinks to enhance stamina have been disclosed in the prior art.

Prinkkila in U.S. Pat. No. 4,853,237 discloses a fitness drink powder containing glucose polymer, various salts, and fruit acid. The drink composition of Prinkkila is designed to be available to the body in an optimal manner. In addition, the drink product is designed to maintain a high sugar concentration in the blood during physical exertion.

In U.S. Pat. No. 5,032,411 Stray-Gunderson discloses a hypotonic beverage with essential electrolytes, minerals and carbohydrates. Because the beverage composition is hypotonic, the stomach empties very rapidly and the composition can produce a beneficial physiologic response.

Kahm in U.S. Pat. No. 4,042,684 discloses a dietetic beverage containing sugar and essential salts. The composition is said to enhance energy stores. In addition, the composition does not require preservatives. The mixture of glucose and fructose used in the composition produces rapid transport of glucose out of the digestive system while fructose is more slowly transported out of the system.

Strahl in U.S. Pat. No. 6,039,987 discloses a composition to prevent dehydration and prevent cramps which contains electrolytes, carbohydrates and quinine.

King in U.S. Pat. No. 5,780,094 discloses a sports beverage containing a saccharide in the amount of 1.25% weight to volume of glucose.

Simone in U.S. Pat. No. 5,397,786 discloses a rehydration drink that contains carbohydrate, various electrolytes and one ammonia neutralizer such as aspartate, arginine and glutamate.

A flavored and sweetened aqueous dietetic beverage used to rehydrate the body is disclosed by Boyle in U.S. Pat. No. 4,874,606. L-aspartyl-L-phenyl-alanine methyl ester is included in the beverage to increase the degree of gastric emptying.

None of the prior art patents disclose the nutritional composition of the present invention for enhancing the duration and intensity of exercise and sport performance, allowing for the immediate initiation of muscle protein synthesis and muscle repair, and elimination of reactive oxygen species that damage muscle and joint tissue.

Accordingly, it is an object of the present invention is to provide a nutritional composition for optimizing muscle performance during exercise.

Another object of the present invention is to provide a nutritional composition that ensures the absorption from the GI tract of every gram of carbohydrate consumed during exercise.

Another object of the present invention is to provide a nutritional composition that ensures the utilization of every gram of carbohydrate consumed during exercise.

Another object of the present invention is to provide a nutritional composition that increases the transport of glucose from the blood into the muscle cell during exercise.

Another object of the present invention is to provide a nutritional composition to ensure replacement of any deficit in fluid, replenish ions necessary for reestablishing fluid homeostasis and plasma osmolality and other critical biological functions.

Another object of the present invention is to provide a nutritional composition to speed the uptake of glucose into the muscle, thereby sparing muscle glycogen stores and extending endurance.

Another object of the present invention is to provide a nutritional composition that provides for the elimination of reactive oxygen species, which damage muscle and joint tissue as a consequence of intensity physical activity.

Another object of the present invention is to provide a nutritional composition allowing for the immediate initiation of muscle protein synthesis and muscle repair.

Another object of the present invention is to provide precursors of the signaling molecule nitric oxide, critical for increasing blood flow and subsequent nutrient delivery to tissue during intense exercise. The endothelium of blood vessels uses nitric oxide to signal the surrounding smooth muscle to relax, thus dilating the artery and increasing blood flow.

Another object of the present invention is to provide precursors to creatine, a molecule critical for ATP regeneration in muscle and nerve cells and for muscle cell volumizing effects. Cell volumization refers to the hydration state of a cell. The volume of fluid within the cell has been shown to help regulate important cellular metabolic events. Research studies have demonstrated that cell swelling decreases protein breakdown while stimulating protein synthesis. A reduction in cell volume promotes protein breakdown and inhibits protein synthesis. Changes in cell volume have also been demonstrated to influence: gene expression, enzymatic activity, hormone effects, and response to signaling molecules. Maintaining cellular hydration is important in optimizing cellular function and protein synthesis. Athletes who do not maintain cell hydration during training may inhibit muscle cell repair which results in a decrease in muscle mass and/or longer recovery time between workouts. In addition, exercise affects cell hydration. Exercise results in continual transfer of fluid and nutrients into and out of the cell, increases oxidative stress, and promotes the release of anabolic hormones.

### SUMMARY OF THE INVENTION

In one preferred embodiment, the present invention provides for a nutritional composition in a dry powder form for optimizing muscle performance during exercise.

In this preferred embodiment, the dry powder nutritional composition has one or more carbohydrates that are sugars in the range of 81.18% to 99.01% by weight of the dry composition wherein the carbohydrates are a mixture of monosaccharides and polysaccharides, and one or more proteins in the range of 0.99% to 18.82% by weight of the dry composition. The dry nutritional composition preferably further includes: a first vitamin being Vitamin C in the range of 0.0% to 0.4% by weight of the dry composition as an antioxidant to prevent and eradicate reactive oxygen species and free radicals generated during strenuous exercise thus preserving muscle cell integrity; a second vitamin being Vitamin E in the range of 0.0% to 0.50% by weight of the dry composition for use as an antioxidant to prevent and eradicate reactive oxygen species and free radicals generated during strenuous exercise thus preserving muscle cell integrity; and a third vitamin being Vitamin A in the range of 0.0% to 0.40% by weight of the dry composition for use as an antioxidant to prevent and eradicate reactive oxygen species and free radicals generated during strenuous exercise thus preserving muscle cell integrity.

In this preferred embodiment, the dry powder nutritional composition preferably also includes a first electrolyte ion being sodium (Na.sup.+) compounds in the range of 0.0% to 0.2% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; a second electrolyte ion being potassium (K.sup.+) compounds in the range of 0.0% to 0.6% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; a third electrolyte ion being magnesium (Mg.sup.+2) compounds in the range of 0.0% to 0.1% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; a fourth electrolyte ion being chloride (Cl.sup.−) compounds in the range of 0.0% to 0.2% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; a fifth electrolyte ion being calcium (Ca.sup.+) compounds in the range of 0.0% to 0.4% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; and a sixth electrolyte ion being Zinc (Zn.sup.+2) compounds in the range of 0.0% to 0.1% by weight of the dry composition important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes.

Additionally, in this preferred embodiment, the dry nutritional composition preferably includes a first amino acid leucine in the range of 1.0% to 2.0% by weight of the dry composition utilized by muscle cells for energy, thus sparing glycogen stores, increasing protein synthesis by elevating insulin and growth hormone, and reducing protein degradation; a second amino acid isoleucine in the range of 0.25% to 1.0% by weight of the dry composition to elevate insulin and growth hormone levels reducing protein degradation and to be utilized by muscle cells for energy, thus sparing glycogen; and a third amino acid valine in the range of 0.25% to 1.0% by weight of the dry composition to elevate insulin and growth hormone levels reducing protein degradation and to be utilized by muscle cells for energy, thus sparing glycogen.

Additionally, in this preferred embodiment, the dry nutritional composition preferably includes a first antioxidant epigallocatechin gallate (EGCG) and green tea polyphenols in the range of 0.0% to 0.5% by weight of the dry composition which has been shown to have protective effects on blood vessels, and a second antioxidant class, that includes ellagitanins, including ellagic acid and punicalagin, in the range of 0.0% to 0.75% by weight of the dry composition which have been shown to have protective effects on both blood vessels as well as inhibiting stimulation of the pro-inflammatory protein interleukin-1b (IL-b) which causes degradation and damage to joints. These antioxidants prevent and eradicate reactive oxygen species and free radicals generated during strenuous exercise, thus preserving muscle integrity.

Preferably, the carbohydrate to protein ratio in the inventive dry powder nutritional composition is about 4.3 or more parts by weight carbohydrate to 1 part by weight protein, and more preferably is in a range between about 8 parts by weight carbohydrate to 1 part by weight protein and about 12 parts by weight carbohydrate to 1 part by weight protein. Even more preferably, the carbohydrate to protein ratio in the inventive dry nutritional composition is about 15 parts by weight carbohydrate to 1 part by weight protein.

Further objects, features, and advantages of the present invention will become apparent upon the consideration of the following detailed description of the presently-preferred embodiments.

### DETAILED DESCRIPTION OF THE PREFERRED EMBODIMENTS

The invention is based on the unexpected and surprising discovery that by providing a nutritional composition that contains carbohydrate, preferably in the form of monosaccharides and polysaccharides, and protein in a ratio higher than 4.2 parts of said carbohydrates to 1.0 part of said protein ensures the absorption from the GI tract and utilization of every gram of carbohydrate consumed during exercise as well as increase the transport of glucose from the blood into the muscle cell during exercise.

A second unexpected and surprising discovery is that a carbohydrate protein ratio higher than the 4.2 of said carbohydrates to 1.0 part of said protein permits protein to be efficiently absorbed by stimulating insulin while not interfering with gastric emptying, which would impact fluid and carbohydrate absorption during exercise.

A third unexpected and surprising discovery is that the nutritional composition of the present invention permits a significant increase in intensity and duration of exercise when compared to a sports drink containing the same amount of carbohydrate.

A fourth unexpected and surprising discovery is that the nutritional composition of the present invention permits a significant increase in intensity and duration of exercise when compared to a sports drink containing a higher level of protein and a lower carbohydrate to protein ratio.

A fifth unexpected and surprising discovery is that the nutritional composition of the present invention significantly reduced gastrointestinal discomfort during and immediately after exercise when compared to a sports drink containing a lower carbohydrate to protein ratio.

A sixth unexpected and surprising discovery is that the nutritional composition of the present invention significantly reduced muscle and joint soreness by reducing and eliminating reactive oxygen species which damage muscle and joints during and after exercise.

The nutritional composition of the preferred embodiments of the present invention are in a dry form, a liquid drink, a bar, and a gel format. The nutritional composition is used to increase the intensity and duration of exercise, reduce reactive oxygen species during and after exercise and allow for the immediate start of muscle repair.

Preferred embodiments of the nutritional composition are described below.

Overall, the nutritional composition for improving muscle performance and extending endurance during exercise in accordance with the invention includes nutritional agents that include carbohydrates and proteins (which preferably have the amino acids leucine, isoleucine, and/or valine), and optionally, but preferably, antioxidant Vitamins E, C, and A, electrolytes, antioxidants EGCG and other green tea polyphenols, ellagic acid, punicalagin, flavoring agents, coloring agents, and/or carriers diluents.

In a particularly preferred embodiment, the invention comprises a nutritional composition in dry powder form that includes the following nutritional agents: carbohydrates and proteins (which preferably have the amino acids leucine, isoleucine, and/or valine), and optionally, but preferably, antioxidant Vitamins E, C, and A, electrolytes, antioxidants EGCG and other green tea polyphenols, ellagic acid, punicalagin, flavoring agents, and/or coloring agents.

Preferably, the carbohydrates include monosaccharides and polysaccharides selected from the group consisting of aldohexoses, disaccharides and polysaccharides, such sugars being glucose, glucose polymers, dextrose, maltose, maltodextrins, maltotriose, lactose, galactose, sucrose, corn syrup, high fructose corn syrup, honey, maple syrup, molasses, beet sugar, cane sugar, and sucanat ketohexoses such sugars being arabinose, ribose, xylose, fructose, levulose, psicose, sorbose, tagatose, sorbitol, and combinations thereof. Total carbohydrates preferably are in the range of 80.33% to 90.78% by weight of the dry nutritional composition, and total carbohydrates of 85.71% by weight of the dry nutritional composition is particularly preferred.

One or more protein compounds are used in the forming of the dry nutritional composition. These proteins are used as a source of insulin stimulation during exercise. Protein sources are selected from the group consisting of calcium or sodium caseinate, whey protein, whey protein concentrate, whey protein isolate, hydrolyzed whey protein, demineralized whey protein, milk protein, soy protein, soy protein isolate, soy protein concentrate, pea protein, rice protein, casein hydrolyzate, meat protein concentrate, soy flour, wheat protein, hydrolyzed wheat protein, yeast concentrate, and combinations thereof. Preferably, the total proteins are in the range of 9.0% to 12% by weight of the dry nutritional composition, and total proteins of 10.3% by weight of the dry nutritional composition is particularly preferred.

Preferably, a first amino acid leucine is in the range of 0.2% to 2.75% by weight of the dry nutritional composition, having a preferred percentage of 1.31% by weight of the dry nutritional composition. Preferably, a second amino acid isoleucine is in the range of 0.0% to 1.75% by weight of the dry nutritional composition, having a preferred percentage of 0.57% by weight of the dry nutritional composition. Preferably, a third amino acid valine is in the overall range of 0.0% to 1.75% by weight of the dry nutritional composition, having a preferred percentage of 0.55% by weight of the dry nutritional composition. Leucine, isoleucine, and valine are used to elevate insulin and growth hormone levels, to reduce protein degradation, and to provide muscle cells with an energy substrate, sparing glycogen.

Preferably, the carbohydrate to protein ratio in the inventive dry powder nutritional composition is about 4.3 or more parts by weight carbohydrate to 1 part by weight protein, and more preferably is in a range between about 8 parts by weight carbohydrate to 1 part by weight protein and about 15 parts by weight carbohydrate to 1 part by weight protein. Even more preferably, the carbohydrate to protein ratio in the inventive dry nutritional composition is about 10.3 parts by weight carbohydrate to 1 part by weight protein.

A first vitamin compound used is Vitamin C preferably in the range of 0.0% to 0.3% by weight of the dry nutritional composition. A percentage of 0.01% of Vitamin C by weight of the dry nutritional composition is particularly preferred. A second vitamin compound used is Vitamin E preferably in the range of 0.0% to 0.3% by weight of the dry nutritional composition. A percentage of 0.01% of Vitamin E by weight of the dry nutritional composition is particularly preferred. A third vitamin compound used is Vitamin A preferably in the range of 0.0% to 0.3% by weight of the dry nutritional composition. A percentage of 0.15% of Vitamin A by weight of the dry nutritional composition is particularly preferred. These vitamins are used as antioxidants for preventing and eliminating reactive oxygen species and free radical formation during exercise.

A first antioxidant compound used is epigallocatechin gallate (EGCG) preferably in the range of 0.0% to 0.7% by weight of said dry nutritional composition. A percentage of 0.23% of EGCG by weight of the dry nutritional composition is particularly preferred. A second antioxidant class used is green tea polyphenols preferably in the range of 0.0% to 0.7% by weight of said dry nutritional composition. A percentage of 0.34% green tea polyphenols by weight of the dry nutritional composition is particularly preferred. A third antioxidant class used is ellagitanins, including ellagic acid and punicalagin, preferably in the range of 0.0% to 0.8% by weight of said dry nutritional composition. A percentage of 0.46% the third antioxidant class by weight of the dry nutritional composition is particularly preferred. A forth antioxidant is Ubiquinone (Coenzyme Q) preferably in the range of 0.0% to 0.7% by weight of said dry nutritional composition. A percentage of 0.23% of the forth antioxidant by weight of the dry nutritional composition is particularly preferred.

Electrolytes being sodium, potassium, magnesium, chloride, calcium and zinc compounds are used within the nutritional composition for replenishing the electrolytes lost during exercise, for facilitating intestinal reabsorption of fluids, and for facilitating energy dependent processes. A first electrolyte being sodium compounds include sodium chloride, sodium acetate, acidic sodium citrate, acidic sodium phosphate, sodium amino salicylate, sodium bicarbonate, sodium bromide, sodium citrate, sodium lactate, sodium phosphate, sodium salicylate, anhydrous sodium sulphate, sodium sulphate, sodium tartrate, sodium benzoate, sodium selenite and sodium molybdate. A second electrolyte being potassium compounds include potassium chloride, potassium acetate, potassium bicarbonate, potassium bromide, potassium citrate, potassium-D-gluconate, monobasic potassium phosphate, potassium tartrate, potassium sorbate, potassium iodide, and acesulfame potassium. A third electrolyte being magnesium compounds include magnesium chloride, magnesium oxide, magnesium sulphate, magnesium carbonate, magnesium aspartate and magnesium silicate. A fourth electrolyte being chloride compounds including sodium chloride, potassium chloride, magnesium chloride and zinc chloride. A fifth electrolyte being calcium compounds including calcium lactate, calcium chloride, calcium carbonate, and calcium gluconate. A sixth electrolyte being zinc compounds include zinc chloride and zinc lactate, zinc picolinate.

A first electrolyte ion being sodium (Na.sup.+) compounds are preferably in the range of 0.01% to 0.62% by weight of the dry nutritional composition, and a percentage of 0.12% by weight of the dry nutritional composition is particularly preferred. A second electrolyte ion being potassium (K.sup.+) compounds are preferably in the range of 0.02% to 0.8% by weight of the dry nutritional composition, and a percentage of 0.47% by weight of the dry nutritional composition is particularly preferred. A third electrolyte ion being magnesium (Mg.sup.+2) compounds are preferably in the range of 0.02% to 0.42% by weight of the dry nutritional composition, and a percentage of 0.06% by weight of the dry nutritional composition is particularly preferred. A fourth electrolyte ion being chloride (Cl.sup−) compounds are preferably in the range of 0.02% to 0.62% by weight of dry nutritional composition, and a percentage of 0.09% by weight of the dry nutritional composition is particularly preferred. A fifth electrolyte ion being calcium (Ca.sup+) compounds are preferably in the range of 0.02% to 0.8% by weight of the dry nutritional composition, and a percentage of 0.16% by weight of the dry nutritional composition is particularly preferred. A sixth electrolyte ion being zinc (Zn.sup+) compounds are preferably in the range of 0.0% to 0.3% by weight of the dry nutritional composition, and a percentage of 0.0% by weight of the dry nutritional composition is preferred in a particularly preferred embodiment of the invention.

Other component constituents of the nutritional composition in dry and liquid form include flavor components and/or colorant components. The flavor component for the nutritional composition of the present invention is provided to impart a particular and characteristic taste and sometimes an aroma to the nutritional composition. The use of a flavor component in the nutritional composition also provides an enhanced aesthetic quality to the nutritional composition which increases the user's appeal in using the product. The flavor component is selected from the group consisting of water soluble natural or artificial extracts that include apple, banana, cherry, cinnamon, cranberry, grape, honeydew, honey, kiwi, lemon, lime, orange, peach, peppermint, pineapple, raspberry, tangerine, watermelon, wild cherry, and equivalents and combinations thereof, being preferably in the overall range of 0.1% to 2% by weight of the dry nutritional composition. A percentage of 0.6% of the flavor component by weight of the dry nutritional composition is particularly preferred.

The colorant component for the nutritional composition of the present invention is provided to impart a characteristic color in conjunction with a particular flavor to the nutritional composition. For example, a purple color is used for a grape flavor or a yellow color for a lemon flavor. The colorant component is selected from the group consisting of: water soluble natural or artificial dyes that include FD&C dyes (food, drug and cosmetic use dyes) of blue, green, orange, red, yellow and violet; iron oxide dyes; ultramarine pigments of blue, pink, red and violet; and equivalents thereof. Preferably, the colorant component is in the range of 0.00% to 2% by weight of the dry nutritional composition, and a preferred percentage of 1.0% of the colorant component by weight of the dry nutritional composition is particularly preferred. The dyes discussed above are well known, and are commercially available materials, with their chemical structure being described, e.g., in 21 C.F.R. Part 74 (as revised Apr. 1, 1988) and the CTFA Cosmetic Ingredient Handbook, (1988), published by the Cosmetics, Toiletry and Fragrancy Association, Inc.

Preferred embodiments of the inventive dry powder nutritional composition are illustrated by the examples shown in Table A. Each composition shown in the examples of Table A is formulated to be mixed into an amount of water such that in accordance with particularly preferred embodiments of the invention the resultant liquid nutritional composition formed is 16 fluid ounces. For instance, with reference to Example 1 of Table A, 21.32 grams of the dry powder nutritional composition of Example 1 of Table A is mixed with 451.88 grams of water to form 16 fluid ounces of a particularly preferred inventive liquid nutritional composition.

The dry powder form of the invention may be made by combining all ingredients in a suitable mixing container and mixing slowly. This may also be accomplished by blending with industry standard powder mixing equipment such as a ribbon blender.

In a particularly preferred embodiment, the invention comprises a liquid nutritional drink composition which is obtained by mixing the dry nutritional composition described above with a diluent such as water. Preferred embodiments of the inventive liquid nutritional drink composition are illustrated by the examples shown in Table B. Each liquid nutritional drink composition shown in the examples of Table B is formed by mixing the dry components with the amount of diluent (e.g., water) needed to obtain, in accordance with particularly preferred embodiments of the invention, 16 fluid ounces of the inventive liquid nutritional drink composition. If other amounts of liquid nutritional drink composition are desired, the amounts of the dry components may be adjusted proportional to match the change in fluid ounces from that of 16 ounces. For example, with reference to the examples of Table B, if 32 fluid ounces of liquid nutritional drink composition is desired to be made, the amounts of each component of the liquid nutritional drink component may be doubled to obtain 32 fluid ounces of liquid nutritional drink composition. Likewise, for example, if 12 fluid ounces of liquid nutritional drink composition is desired to be made, the amounts of each component for each example in Table B may be reduced by ¼.

The inventive liquid nutritional drink composition for improving muscle performance and extending endurance during exercise includes nutritional agents that include carbohydrates (as described above), proteins (as described above)(which may have the amino acids leucine, isoleucine, and/or valine), and a diluent, and optionally, but preferably, antioxidant Vitamins E, C, and A, electrolytes (as described above), antioxidants EGCG and other green tea polyphenols, ellagic acid, punicalagin, flavoring agents (as described above), and/or coloring agents (as described above).

Total carbohydrates are preferably in the range of 3.45% to 10% by weight of the liquid nutritional drink composition, and more preferable are in a range of 3.74% to 4.04% by weight of the liquid nutritional drink composition.

Total proteins are preferably in the range of 0.1% to 0.8% by weight of the liquid nutritional drink composition, and more preferable are in a range of 0.37% to 0.60% by weight of the liquid nutritional drink composition.

A first amino acid leucine is preferably in the range of 0.0% to 1.4% by weight of the liquid nutritional drink composition, and a percentage of 0.06% of leucine by weight of the liquid nutritional drink composition is particularly preferred. A second amino acid isoleucine is preferably in the range of 0.0% to 0.8% by weight of the liquid drink nutritional composition, and a percentage of 0.02% of isoleucine by weight of the liquid nutritional drink composition is particularly preferred. A third amino acid valine is preferably in the range of 0.0% to 0.8% by weight of the liquid nutritional drink composition, and a percentage of 0.02% of valine by weight of the liquid nutritional drink composition is particularly preferred.

When the protein level exceeds 1% of the weight in the final liquid composition, the protein has an adverse effect on gastric emptying which slows rehydration and glucose absorption during exercise. Our research has shown that using protein levels of 0.35% to 0.75%, more preferably 0.45% to 0.55%, of the weight in the final liquid composition results in optimal glucose uptake during exercise with no negative impact on gastric emptying and rehydration.

Preferably, the carbohydrate to protein ratio in the inventive liquid nutritional drink composition is about 4.3 or more parts by weight carbohydrate to 1 part by weight protein, and more preferably is in a range between about 8 parts by weight carbohydrate to 1 part by weight protein and about 15 parts by weight carbohydrate to 1 part by weight protein. Even more preferably, the carbohydrate to protein ratio in the inventive liquid nutritional drink composition is about 10.3 parts by weight carbohydrate to 1 part by weight protein.

A first vitamin compound used is Vitamin C in the range of 0.0% to 0.2% by weight of the liquid nutritional drink composition, and a percentage of 0.00% of Vitamin C by weight of the liquid nutritional drink composition is particularly preferred. A second vitamin compound used is Vitamin E preferably in the range of 0.0% to 0.2% by weight of the liquid nutritional drink composition, and a percentage of 0.0% of Vitamin E by weight of the liquid nutritional drink composition is particularly preferred. A third vitamin compound used is Vitamin A preferably in the range of 0.0% to 0.2% by weight of the liquid nutritional drink composition, and a percentage of 0.0% of Vitamin A by weight of the liquid nutritional drink composition is particularly preferred. These vitamins are used as antioxidants for preventing free radical formation during exercise.

A first electrolyte ion being sodium (Na.sup.+) compounds are preferably in the range of 0.0% to 0.2% by weight of the liquid nutritional drink composition. A second electrolyte ion being potassium (K.sup.+) compounds are preferably in the range of 0.0% to 0.4% by weight of the liquid nutritional drink composition. A third electrolyte ion being magnesium (Mg.sup.+2) compounds are preferably in the range of 0.0% to 0.2% by weight of the liquid nutritional drink composition. A fourth electrolyte ion being chloride (Cl.sup−) compounds are preferably in the range of 0.0% to 0.2% by weight of liquid nutritional drink composition. A fifth electrolyte ion being calcium (Ca.sup+) compounds are preferably in the range of 0.0% to 0.2% by weight of the liquid nutritional drink composition. A sixth electrolyte ion being zinc (Zn.sup+2) compounds are preferably in the range of 0.0% to 0.2% by weight of the liquid nutritional drink composition.

A first antioxidant compound used is epigallocatechin gallate (EGCG) preferably in the range of 0.0% to 0.2% by weight of said liquid nutritional drink composition; a second antioxidant group used is green tea polyphenols preferably in the range of 0.0% to 0.2% by weight of said liquid nutritional drink composition; a third antioxidant class used is ellagitanins, including ellagic acid and punicalagin, preferably in the range of 0.0% to 0.3% by weight of said liquid nutritional drink composition; and a forth antioxidant class used is ellagitanins, including Ubiquinonein, preferably in the range of 0.0% to 0.2% by weight of said liquid nutritional drink composition.

The flavor component is preferably in the range of 0.0% to 1.1% by weight of the liquid nutritional drink composition, and a range of 0.05% to 0.40% of the flavor component by weight of the liquid nutritional drink composition is particularly preferred.

The colorant component is preferably in the range of 0.00% to 0.33% by weight of the liquid nutritional drink composition, and a range of 0.00% to 0.08% of the colorant component by weight of the liquid nutritional drink composition is particularly preferred.

The liquid form of the invention may be made by adding the inventive dry powder nutritional composition to a sufficient amount of diluent(s) and mixing until dissolved. Another way to make the liquid form is by adding all ingredients into a suitable container for drinking out of and then dissolving with the appropriate diluents. Any diluent or combination of diluents may be used; however, the components of the diluent(s) need to be accounted for to ensure the final composition is in accordance with component requirements of the invention. For instance, if the dilutent includes a carbohydrate, the amount of carbohydrate in the diluent needs to be accounted for so that the total amount of carbohydrates (the sum of the carbohydrates already in the diluent plus the carbohydrate being mixed into the diluent) in accordance with what is called for by the invention.

In use, a person exercising preferably gradually ingests 16 fluid ounces of the inventive liquid nutritional drink composition during each half hour of exercise. Preferably, it is also desirable to gradually ingest 16 fluid ounces of the inventive liquid nutritional drink composition during both the half hour before the start of exercise and the half hour following exercise.

Other embodiments for the nutritional composition include energy bars where the carrier is in the form of chocolate, oats, wheat, peanut butter, semi-dried fruits, grains and combinations thereof; a gel; a concentrated liquid; or any other form of delivery system suitable for humans.

The gel form of the invention may be made by adding the inventive the dry powder nutritional composition to a sufficient amount of diluent(s) to produce the gel consistency desired and mixing until dissolved. The more diluent(s) added, the lower the viscosity becomes until it becomes liquid. Any diluents or combination of diluent(s) may be used; however, components of the diluent(s) need to be accounted for to ensure the final composition is in accordance with component requirements of the invention. For instance, if the dilutent includes a carbohydrate, the amount of carbohydrate in the diluent needs to be accounted for so that the total amount of carbohydrates (the sum of the carbohydrates already in the diluent plus the carbohydrate being mixed into the diluent) in accordance with what is called for by the invention.

A concentrated liquid form of the invention may be made by mixing the inventive dry powder nutritional composition into the minimum amount of dilutents(s) needed to produce a concentrated liquid composition. Alternatively, the diluent(s) may be mixed slowly into the dry powder form of the invention until the powders are dissolved. The more diluent you add, the lower the viscosity of the concentrated liquid becomes. Any diluent or combination of diluents may be used; however the components of the diluent(s) need to be accounted for to ensure the final composition is in accordance with component requirements of the invention. For instance, if the dilutent includes a carbohydrate, the amount of carbohydrate in the diluent needs to be accounted for so that the total amount of carbohydrates (the sum of the carbohydrates already in the diluent plus the carbohydrate being mixed into the diluent) in accordance with what is called for by the invention.

A carrier form of the invention may be made by combining the dry ingredients of the dry powder nutritional composition with some form of wet carrier (e.g., a diluent, molasses, peanut butter, semi-dried fruits, honey). The wet carrier binds the dry ingredients of the dry powder nutritional composition together to form a distinct form, bar, etc. Another way to make the carrier form of the invention is to add a dry carrier (e.g., chocolate, oats, wheat, grains) to the dry composition and then to mix with diluent(s) until the desired texture and flavor are reached. In addition, a combination of dry carriers and diluents may be used. Any carrier and/or diluent(s) may be used; however, the type of carrier and diluent(s), and the amount(s) of carrier and diluent present, have to be specifically formulated to account for the components of the carrier and diluent(s) to ensure the final composition is in accordance with component requirements of the invention, and has the desired texture and flavor. For instance, if the dilutent includes a carbohydrate, the amount of carbohydrate in the diluent needs to be accounted for so that the total amount of carbohydrates (the sum of the carbohydrates already in the diluent plus the carbohydrate being mixed into the diluent) in accordance with what is called for by the invention. Further, for instance, if the carrier (e.g., peanut butter) includes a protein, the amount of protein in the peanut butter needs to be accounted for so that the total amount of protein (the sum of the protein in the peanut butter plus the protein being mixed into the peanut butter) is in accordance with what is called for by the invention.

Like the dry powder nutritional composition and the liquid nutritional drink composition, the energy bars, gels, concentrated liquids, and other delivery system forms made in accordance with the invention all preferably have a carbohydrate to protein ratio of about 4.3 or more parts by weight carbohydrate to 1 part by weight protein, and more preferably have a carbohydrate to protein ratio in a range between about 8 parts by weight carbohydrate to 1 part by weight protein and about 15 parts by weight carbohydrate to 1 part by weight protein, and even more preferably the carbohydrate to protein ratio is about 10.3 parts by weight carbohydrate to 1 part by weight protein. Further, with respect to the energy bars, gels, concentrated liquids, and other delivery system forms of the invention, the amounts and ranges of the total carbohydrates and proteins, as well as the optional components of Vitamins E, C, and A, electrolytes, antioxidants EGCG and other green tea polyphenols, ellagic acid, punicalagin, flavoring agents, and coloring agents in an energy bar, in a gel, in a concentrated liquid, and in an other delivery system form of the invention preferably are such that if such components of the energy bar or gel or concentrated liquid or other delivery system form were mixed into water to form a 16 fluid ounce mixture, the amounts and the ranges for each component in such a 16 fluid ounce mixture would match the preferred amounts and ranges set out above for the inventive liquid nutritional composition. Like the liquid nutritional drink composition, it is preferred that the protein level in an energy bar, a gel, a concentrated liquid, or other delivery system form be such that if the amount of protein in the energy bar or gel or concentrated liquid or other delivery system form were mixed into water to form a 16 fluid ounce mixture, the protein level in the 16 fluid ounce mixture preferably does not exceed the percentage by weight of 1%, and preferably 0.35% to 0.75%, and more preferably 0.45% to 0.55%, by weight of the 16 fluid ounce mixture, to limit an adverse effect of protein on gastric emptying which slows rehydration and glucose absorption during exercise. Such a limit on protein levels facilitates glucose uptake during exercise with no negative impact on gastric emptying and rehydration.

### Advantages of the Present Invention

Accordingly, an advantage of the present invention is that it provides for a nutritional composition for optimizing muscle performance during exercise without delayed gastric emptying or other adverse effects on the gastrointestinal track.

Another advantage of the present invention is that it provides precursors to creatine, a molecule critical for ATP regeneration in muscle and nerve cells and for muscle cell volumizing effects. Cell volumization refers to the hydration state of a cell. The volume of fluid within the cell has been shown to help regulate important cellular metabolic events. Research studies have demonstrated that cell swelling decreases protein breakdown while stimulating protein synthesis. A reduction in cell volume promotes protein breakdown and inhibits protein synthesis. Changes in cell volume have also been demonstrated to influence: gene expression, enzymatic activity, hormone effects, and response to signaling molecules.

Maintaining cellular hydration is important in optimizing cellular function and protein synthesis. Athletes who do not maintain cell hydration during training may inhibit muscle cell repair which results in a decrease in muscle mass and/or longer recovery time between workouts. In addition, exercise affects cell hydration. Exercise results in continual transfer of fluid and nutrients into and out of the cell, increases oxidative stress, and promotes the release of anabolic hormones.

Another advantage of the present invention is that it provides precursors of the signaling molecule nitric oxide, critical for increasing blood flow and subsequent nutrient delivery to muscle tissue during intense exercise.

Another advantage of the present invention is that it provides a nutritional composition that speeds the uptake of glucose into the muscle cells during exercise.

Another advantage of the present invention is that it provides a nutritional composition that increases the efficiency of every gram of every carbohydrate consumed during exercise.

Another advantage of the present invention is that it provides for a nutritional composition for restoring fluid and electrolytes, and for replenishing glycogen stores in the muscle and for reducing oxidative and muscle stress.

Another advantage of the present invention is that it provides for a nutritional composition to speed the uptake of glycogen into the muscle, thereby sparing muscle glycogen stores and extending endurance.

Another advantage of the present invention is that it provides for a nutritional composition that restores fluid and electrolyte levels that are depleted during exercise.

Another advantage of the present invention is that it provides for a nutritional composition that reduces oxidative stress by preventing and eliminating reactive oxygen species and free radicals that form as a consequence of exercise.

Another advantage of the present invention is that it provides a nutritional composition that allows for the immediate start of muscle repair during exercise.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

TABLE A
EXAMPLES OF PREFERRED EMBODIMENTS OF THE DRY NUTRITIONAL COMPOSITION

| | | Example 1 | Example 2 | Example 3 | Example 4 | Example 5 | Example 6 | Example 7 |
|---|---|---|---|---|---|---|---|---|
| | Ingredient | (grams) | (grams) | (grams) | (grams) | (grams) | (grams) | (grams) |
| 1 | Carbohydrate in | 18.27 | 17.68 | 19.12 | 16.33 | 47.32 | 16.33 | 28.39 |
| | the form of | | | | | | | |
| | monosaccharides | | | | | | | |
| | and | | | | | | | |
| | polysaccharides | | | | | | | |
| 2 | Protein | 2.19 | 1.75 | 2.19 | 0.47 | 3.79 | 0.47 | 2.84 |
| 3 | electrolyte Na | 0.03 | 0 | 0.14 | 0 | 1.18 | 0 | 0.85 |
| 4 | electrolyte K | 0.1 | 0 | 0.18 | 0 | 2.13 | 0.09 | 1.75 |
| 5 | electrolyte Mg | 0.01 | 0 | 0.09 | 0 | 1.18 | 0.09 | 0.8 |
| 6 | electrolyte Cl | 0.02 | 0 | 0.14 | 0 | 1.18 | 0.09 | 0.71 |
| 7 | electrolyte Ca | 0.04 | 0 | 0.18 | 0 | 1.18 | 0.09 | 0.71 |
| 8 | electrolyte Zn | 0 | 0 | 0.07 | 0 | 1.18 | 0 | 0.71 |
| 9 | vitamin C | 0 | 0 | 0.07 | 0 | 1.18 | 0 | 0.71 |
| 10 | vitamin E | 0 | 0 | 0.07 | 0 | 1.18 | 0 | 0.71 |
| 11 | vitamin A | 0.03 | 0 | 0.07 | 0 | 1.18 | 0 | 0.71 |
| 12 | Epigallocatechin | 0.05 | 0 | 0.15 | 0 | 1.18 | 0 | 0.76 |
| | gallate (EGCG) | | | | | | | |
| 13 | Polyphenols | 0.08 | 0 | 0.15 | 0 | 1.18 | 0 | 0.9 |
| 14 | Ellagic Acid | 0.1 | 0 | 0.18 | 0 | 1.66 | 0 | 1.28 |
| 15 | Ubiquinone | 0.05 | 0 | 0.15 | 0 | 0.87 | 0 | 0.66 |
| 16 | Flavor | 0.13 | 0.02 | 0.44 | 0 | 9.46 | 0.47 | 4.73 |
| 17 | Colorant | 0.22 | 0 | 0.44 | 0 | 1.89 | 0 | 1.42 |
| | Total | 21.32 | 19.47 | 23.8 | 16.8 | 78.95 | 17.65 | 48.64 |

TABLE B
EXAMPLES OF PREFERRED EMBODIMENTS OF THE LIQUID COMPOSITION

| | | Example 1 | Example 2 | Example 3 | Example 4 | Example 5 | Example 6 | Example 7 |
|---|---|---|---|---|---|---|---|---|
| | Ingredient | (grams) | (grams) | (grams) | (grams) | (grams) | (grams) | (grams) |
| 1 | Carbohydrate in | 18.27 | 17.68 | 19.12 | 16.33 | 47.32 | 16.33 | 28.39 |
| | the for of | | | | | | | |
| | monosaccharides | | | | | | | |
| | and | | | | | | | |
| | polysaccharides | | | | | | | |
| 2 | Protein | 2.19 | 1.75 | 2.19 | 0.47 | 3.79 | 0.47 | 2.84 |
| 3 | electrolyte Na | 0.03 | 0 | 0.14 | 0 | 1.18 | 0 | 0.85 |
| 4 | electrolyte K | 0.1 | 0 | 0.18 | 0 | 2.13 | 0.09 | 1.75 |
| 5 | electrolyte Mg | 0.01 | 0 | 0.09 | 0 | 1.18 | 0.09 | 0.8 |
| 6 | electrolyte Cl | 0.02 | 0 | 0.14 | 0 | 1.18 | 0.09 | 0.71 |
| 7 | electrolyte Ca | 0.04 | 0 | 0.18 | 0 | 1.18 | 0.09 | 0.71 |
| 8 | electrolyte Zn | 0 | 0 | 0.07 | 0 | 1.18 | 0 | 0.71 |
| 9 | vitamin C | 0 | 0 | 0.07 | 0 | 1.18 | 0 | 0.71 |
| 10 | vitamin E | 0 | 0 | 0.07 | 0 | 1.18 | 0 | 0.71 |
| 11 | vitamin A | 0.03 | 0 | 0.07 | 0 | 1.18 | 0 | 0.71 |
| 12 | Epigallocatechin | 0.05 | 0 | 0.15 | 0 | 1.18 | 0 | 0.76 |
| | gallate | | | | | | | |
| | (EGCG) | | | | | | | |
| 13 | Polyphenols | 0.08 | 0 | 0.15 | 0 | 1.18 | 0 | 0.9 |
| 14 | Ellagic Acid | 0.1 | 0 | 0.18 | 0 | 1.66 | 0 | 1.28 |
| 15 | Ubiquinone | 0.05 | 0 | 0.15 | 0 | 0.87 | 0 | 0.66 |
| 16 | Flavor | 0.13 | 0.02 | 0.44 | 0 | 9.46 | 0.47 | 4.73 |
| 17 | Colorant | 0.22 | 0 | 0.44 | 0 | 1.89 | 0 | 1.42 |
| 18 | Diluent | 451.88 | 453.73 | 449.4 | 456.4 | 394.25 | 455.55 | 424.56 |
| | Total | 473.2 | 473.2 | 473.2 | 473.2 | 473.2 | 473.2 | 473.2 |

What is claimed is:

1. A nutritional composition, for ingestion before, during, and after exercise, for synthesizing and regenerating ATP in muscle cells and neurons, repairing exercise-induced muscle fiber damage, repletion of glycogen stores in the muscle and liver, enhancing blood flow to tissue during intense exercise, and preventing and reducing oxidative damage to tissues during exercise with minimal gastrointestinal disturbances, comprising: a carbohydrate portion and a protein portion, the carbohydrate portion to protein portion being present in the composition in a ratio of about 4.3 or more parts by weight carbohydrate to 1 part by weight protein.

2. A nutritional composition in accordance with claim 1, the composition being in a dry powder form, wherein the carbohydrate portion comprises one or more carbohydrates in a range of 57.3% to 99.01% by weight of said dry powder nutritional composition, and the protein portion comprises one or more proteins being in a range of 0.99% to 18.82% by weight of said dry powder nutritional composition.

3. A nutritional composition in accordance with claim 2, further including a first vitamin compound being Vitamin C, further including a second vitamin compound being Vitamin E, further including a third vitamin compound being Vitamin A or a combination thereof.

4. A nutritional composition in accordance with claim 2, further including: an essential amino acid being leucine, which is broken down into glucose more rapidly than other branch-chain amino acids (BCAA) and utilized by muscle cells for energy thus sparing glycogen stores, for increasing protein synthesis by elevating insulin and growth hormone and reducing protein degradation after physiological stress; an essential amino acid being isoleucine, utilized by muscle cells for energy thus sparing glycogen stores, increasing protein synthesis by elevating insulin and growth hormone, and required for the formation of the oxygen carrying compound hemoglobin and blood clots at injury sites; and an essential amino acid being valine, utilized by muscle cells for energy thus sparing glycogen stores and increasing protein synthesis by elevating insulin and growth hormone; or a combination thereof.

5. A nutritional composition in accordance with claim 2, further including: a) a first electrolyte ion being sodium (Na.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; b) a second electrolyte ion being potassium (K.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; c) a third electrolyte ion being magnesium (Mg.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; d) a fourth electrolyte ion being chloride (Cl.sup.−) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; e) a fifth electrolyte ion being calcium (Ca.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; or f) a sixth electrolyte ion being zinc (Zn.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; or a combination of said electrolytes.

6. A nutritional composition in the accordance with claim 2, wherein said carbohydrate portion comprises monosaccharides, or polysaccharides, or a combination thereof selected from the group consisting of aldohexoses, disaccharides and polysaccharides, such sugars being glucose, glucose polymers, dextrose, maltose, maltodextrins, maltotriose, lactose, galactose, sucrose, corn syrup, high fructose corn syrup, honey, maple syrup, molasses, beet sugar, cane sugar, and sucanat ketohexoses such sugars being arabinose, ribose, xylose, fructose, levulose, psicose, sorbose, tagatose, sorbitol, and combinations thereof.

7. A nutritional composition in the accordance with claim 1, where said mixture contains epigallocatechin gallate (EGCG), polyphenols, ellagic acid, punicalagin, or ubiquinone, or a combination thereof.

8. A nutritional composition in the accordance with claim 2, wherein said proteins are selected from the group consisting of calcium caseinate, sodium caseinate, potassium caseinate, whey protein, whey protein concentrate, whey protein isolate, hydrolyzed whey protein, demineralized whey protein, milk protein, soy protein, soy protein isolate, soy protein concentrate, pea protein, rice protein, casein hydrolyzate, meat protein concentrate, soy flour, wheat protein, hydrolyzed wheat protein, yeast concentrate, and combinations thereof.

9. A nutritional composition in the accordance with claim 5, where said sodium (Na+) compounds are selected from the group consisting of sodium chloride, sodium acetate, acidic sodium citrate, acidic sodium phosphate, sodium amino salicylate, sodium bicarbonate, sodium bromide, sodium citrate, sodium lactate, sodium phosphate, sodium salicylate, anhydrous sodium sulphate, sodium sulphate, sodium tartrate, sodium benzoate, sodium selenite, sodium molybdate, and combinations thereof; and where said potassium (K.sup.+) compounds are selected from the group consisting of potassium chloride, potassium acetate, potassium bicarbonate, potassium bromide, potassium citrate, potassium-D-gluconate, monobasic potassium phosphate, potassium tartrate, potassium sorbate, potassium iodide, acesulfame potassium, and combination thereof; and wherein said magnesium (Mg.sup.+) compounds are selected from the group consisting of magnesium chloride, magnesium oxide, magnesium sulphate, magnesium carbonate, magnesium aspartate, magnesium silicate, and combinations thereof; and where said chloride (Cl.sup.−) compounds are selected from the group consisting of sodium chloride, potassium chloride, magnesium chloride, zinc chloride, and combinations thereof; and wherein said calcium (Ca.sup.+) compounds are selected from the group consisting of calcium lactate, calcium chloride, calcium gluconate, calcium carbonate, and combinations thereof; and where said zinc (Zn.sup.+) compounds are selected from the group consisting of zinc chloride, zinc lactate, zinc picolinate, and combinations thereof.

10. A nutritional composition in the accordance with claim 2, further including a flavor component for imparting a characteristic taste to said nutritional composition; and further including a colorant for imparting a characteristic color to said nutritional composition.

11. A nutritional composition in accordance with claim 1, further including a diluent into which the carbohydrate portion and the protein portion are mixed forming a liquid nutritional composition, wherein the carbohydrate portion comprises one or more carbohydrates in a range of 3.45% to 10% by weight of said liquid nutritional composition, the protein portion comprises one or more proteins being in the range of 0.1% to 0.8% by weight of said liquid nutritional composition, and the diluent is in a range of 89.2% to 96.45% by weight of said liquid composition for providing a liquid carrier for the carbohydrate portion and the protein portion.

12. A nutritional composition in accordance with claim 11, further including a first vitamin compound being Vitamin C, a second vitamin compound being Vitamin E, and a third vitamin compound being Vitamin A.

13. A nutritional composition in accordance with claim 11, further including: an essential amino acid being leucine, which is broken down into glucose more rapidly than other branch-chain amino acids (BCAA) and utilized by muscle cells for energy thus sparing glycogen stores, for increasing protein synthesis by elevating insulin and growth hormone and reducing protein degradation after physiological stress; an essential amino acid being isoleucine, utilized by muscle cells for energy thus sparing glycogen stores, increasing protein synthesis by elevating insulin and growth hormone, and required for the formation of the oxygen carrying compound hemoglobin and blood clots at injury sites; and an important amino acid being valine, utilized by muscle cells for energy thus sparing glycogen stores and increasing protein synthesis by elevating insulin and growth hormone; or a combination thereof.

14. A nutritional composition in accordance with claim 11, further including: a) a first electrolyte ion being sodium (Na.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; b) a second electrolyte ion being potassium (K.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; c) a third electrolyte ion being magnesium (Mg.sup.+2) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; d) a fourth electrolyte ion being chloride (Cl.sup.−) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; e) a fifth electrolyte ion being calcium (Ca.sup.+) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; or f) a sixth electrolyte ion being zinc (Zn.sup.+2) compounds important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; or a combination of said electrolytes.

15. A nutritional composition in the accordance with claim 11, wherein said carbohydrate is a monosaccharide, or a polysaccharide, or a combination thereof selected from the group consisting of aldohexoses, disaccharides and polysaccharides, such sugars being glucose, glucose polymers, dextrose, maltose, maltodextrins, maltotriose, lactose, galactose, sucrose, corn syrup, high fructose corn syrup, honey, maple syrup, molasses, beet sugar, cane sugar, and sucanat ketohexoses such sugars being arabinose, ribose, xylose, fructose, levulose, psicose, sorbose, tagatose, sorbitol, and combinations thereof.

16. A nutritional composition in the accordance with claim 11, where said mixture contains epigallocatechin gallate (EGCG), polyphenols, ellagic acid, punicalagin, or ubiquinone, or a combination thereof.

17. A nutritional composition in the accordance with claim 11, wherein said proteins are selected from the group consisting of calcium caseinate, sodium caseinate, potassium caseinate, whey protein, whey protein concentrate, whey protein isolate, hydrolyzed whey protein, demineralized whey protein, milk protein, soy protein, soy protein isolate, soy protein concentrate, pea protein, rice protein, casein hydrolyzate, meat protein concentrate, soy flour, wheat protein, hydrolyzed wheat protein, yeast concentrate, and combinations thereof.

18. A nutritional composition in the accordance with claim 14, where said sodium (Na+) compounds are selected from the group consisting of sodium chloride, sodium acetate, acidic sodium citrate, acidic sodium phosphate, sodium amino salicylate, sodium bicarbonate, sodium bromide, sodium citrate, sodium lactate, sodium phosphate, sodium salicylate, anhydrous sodium sulphate, sodium sulphate, sodium tartrate, sodium benzoate, sodium selenite, sodium molybdate, and combinations thereof; and where said potassium (K.sup.+) compounds are selected from the group consisting of potassium chloride, potassium acetate, potassium bicarbonate, potassium bromide, potassium citrate, potassium-D-gluconate, monobasic potassium phosphate, potassium tartrate, potassium sorbate, potassium iodide, acesulfame potassium, and combinations thereof; and wherein said magnesium (Mg.sup.+) compounds are selected from the group consisting of magnesium chloride, magnesium oxide, magnesium sulphate, magnesium carbonate, magnesium aspartate, magnesium silicate, and combinations thereof; and where said chloride (Cl.sup.−) compounds are selected from the group consisting of sodium chloride, potassium chloride, magnesium chloride and zinc chloride; and wherein said calcium (Ca.sup.+) compounds are selected from the group consisting of calcium lactate, calcium chloride, calcium gluconate, calcium carbonate, and combinations thereof; and where said zinc (Zn.sup.+) compounds are selected from the group consisting of zinc chloride, zinc lactate, zinc picolinate, and combinations thereof.

19. A nutritional composition in the accordance with claim 11, further including a flavor component for imparting a characteristic taste to said nutritional composition, and further including a colorant for imparting a characteristic color to said nutritional composition.

20. A nutritional composition in a dry powder form for optimizing human physiological performance during intense exercise and subsequently returning the body to its healthy, pre-exercise state following the cessation of exercise, comprising: a) carbohydrates for providing energy during exercise; b) proteins for stimulating the release of insulin to the muscle cells during exercise and for repairing muscle cells after exercise; c) leucine to increase protein synthesis by elevating insulin and growth hormone, to reduce protein degradation, and to be utilized by muscle cells for energy thus sparing glycogen; d) isoleucine to increase protein synthesis by elevating insulin and growth hormone and to be utilized by muscle cells for energy thus sparing glycogen; e) valine to increase protein synthesis by elevating insulin and growth hormone and to be utilized by muscle cells for energy, sparing glycogen; f) Vitamin C for use as an antioxidant to prevent and eradicate reactive oxygen species and free radicals generated during strenuous exercise thus preserving muscle cell integrity; g) Vitamin E for use as an antioxidant to prevent and eradicate reactive oxygen species and free radicals generated during strenuous exercise thus preserving muscle cell integrity; h) Vitamin A for use as an antioxidant to prevent and eradicate reactive oxygen species and free radicals generated during strenuous exercise thus preserving muscle cell integrity; i) one or more electrolytes important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; j) epigallocatechin gallate (EGCG) and green tea polyphenols; k) ellagic acid and punicalagin; and l) ubiquinone (coenzyme Q); wherein the carbohydrates and proteins are present in the composition in a ratio of about 4.3 or more parts by weight carbohydrates to 1 part by weight protein.

21. A nutritional composition in a liquid form for optimizing human physiological performance during intense exercise and subsequently returning the body to its healthy, pre-exercise state following the cessation of exercise, comprising: a) carbohydrates for providing energy during exercise; b) proteins for stimulating the release of insulin to the muscle cells during exercise and for repairing muscle cells after exercise; c) leucine to increase protein synthesis by elevating insulin and growth hormone, to reduce protein degradation, and to be utilized by muscle cells for energy thus sparing glycogen; d) isoleucine to increase protein synthesis by elevating insulin and growth hormone and to be utilized by muscle cells for energy thus sparing glycogen; e) valine to increase protein synthesis by elevating insulin and growth hormone and to be utilized by muscle cells for energy, sparing glycogen; f) Vitamin C for use as an antioxidant to prevent and eradicate reactive oxygen species and free radicals generated during strenuous exercise thus preserving muscle cell integrity; g) Vitamin E for use as an antioxidant to prevent and eradicate reactive oxygen species and free radicals generated during strenuous exercise thus preserving muscle cell integrity; h) Vitamin A for use as an antioxidant to prevent and eradicate reactive oxygen species and free radicals generated during strenuous exercise thus preserving muscle cell integrity; i) one or more electrolytes important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; j) epigallocatechin gallate (EGCG) and green tea polyphenols; k) ellagic acid and punicalagin; and l) ubiquinone (coenzyme Q); wherein the carbohydrates and proteins are present in the composition in a ratio of about 4.3 or more parts by weight carbohydrates to 1 part by weight protein.

22. A nutritional composition in a gel form for optimizing human physiological performance during intense exercise and subsequently returning the body to its healthy, pre-exercise state following the cessation of exercise, comprising: a) carbohydrates for providing energy during exercise; b) proteins for stimulating the release of insulin to the muscle cells during exercise and for repairing muscle cells after exercise; c) leucine to increase protein synthesis by elevating insulin and growth hormone, to reduce protein degradation, and to be utilized by muscle cells for energy thus sparing glycogen; d) isoleucine to increase protein synthesis by elevating insulin and growth hormone and to be utilized by muscle cells for energy thus sparing glycogen; e) valine to increase protein synthesis by elevating insulin and growth hormone and to be utilized by muscle cells for energy, sparing glycogen; f) Vitamin C for use as an antioxidant to prevent and eradicate reactive oxygen species and free radicals generated during strenuous exercise thus preserving muscle cell integrity; g) Vitamin E for use as an antioxidant to prevent and eradicate reactive oxygen species and free radicals generated during strenuous exercise thus preserving muscle cell integrity; h) Vitamin A for use as an antioxidant to prevent and eradicate reactive oxygen species and free radicals generated during strenuous exercise thus preserving muscle cell integrity; i) one or more electrolytes important for the muscle fiber contraction and relaxation cycle, for neuronal signal propagation, for repletion of such ions lost in excessive perspiration during exercise, for water absorption in the gastrointestinal tract, and for catalytic action by energy producing and antioxidant enzymes; j) epigallocatechin gallate (EGCG) and green tea polyphenols; k) ellagic acid and punicalagin; and l) ubiquinone (coenzyme Q); wherein the carbohydrates and proteins are present in the composition in a ratio of about 4.3 or more parts by weight carbohydrates to 1 part by weight protein.
